(19) United States
(12) Patent Application Publication
(10) Pub. No.: US 2008/0209495 A1
(43) Pub. Date: Aug. 28, 2008

(54) AUDIO VIDEO NETWORK SYSTEM , SET-TOP BOX, IMAGE DISPLAY APPARATUS AND METHOD FOR OFFERING USER INTERFACE

(75) Inventors: Yong-chan Kwon, Anyang-si (KR); Sung-ouk Chae, Seoul (KR); Kyung-soo Lee, Seoul (KR); Hyung-chan Kim, Yongin-si (KR); Chang-gi Kwon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/859,338

(22) Filed: Sep. 21, 2007

(30) Foreign Application Priority Data
Feb. 27, 2007 (KR) 10-2007-0019664

(51) Int. Cl. H04N 7/173

(52) U.S. Cl. 725/131

(57) ABSTRACT

A home audio video network system for providing a remote user interface (UI) to image display apparatuses coupled to a set-top box, a set-top box, an image display apparatus and a method for offering a UI are provided. The system includes a set-top box which analyzes an event and outputs user interface (UI) data corresponding to the event; and an image display apparatus which renders and displays a UI according to the UI data. The set-top box includes a storage unit; an application unit; a UI process unit; and a UI offer unit. The image display apparatus includes a UI transmission and reception unit; a UI rendering unit; and a display unit. The method includes analyzing an event and transmitting UI data corresponding to the event to the image display apparatus; and rendering and displaying a UI according to the UI data by the image display apparatus.

### CROSS-REFERENCE TO RELATED PATENT APPLICATION

This application claims priority from Korean Patent Application No. 10-2007-0019664, filed in the Korean Intellectual Property Office on Feb. 27, 2007, the entire disclosure of which is incorporated herein by reference.

### BACKGROUND OF THE INVENTION

1. Field of the Invention

Systems, apparatuses, and methods consistent with the present invention relate to a user interface (UI) transmission system, a set-top box, an image display apparatus and a method for offering a UI, and more particularly, to a home audio and video (A/V) network system for efficiently providing a remote UI to the image display apparatuses connected to a set-top box, and a set-top box, an image display apparatus and a method for offering a UI.

2. Description of the Related Art

In general, home A/V networks, such as High-definition Audio-Video Network Alliance (HANA) networks or Digital Living Network Alliance (DLNA) networks, connect a digital television (DTV), set-top box (STB), recorder and so on via a single cable so as to enable content transmission and device manipulation, and center around the DTV.

In such a home A/V network, UIs for all the devices are displayed on the DTV. Accordingly, UIs rendered from a JAVA application in the devices have to be transmitted to the DTV.

FIG. 1 is a block diagram illustrating a configuration of a related art UI offering system.

In FIG. 1, the related art UI offering system 100 includes a set-top box 10 which performs an operation of a JAVA application for Open Cable Application Platform (OCAP) service, and a digital television (DTV) 20 which is connected to an red-green-blue (RGB) cable.

The OCAP service is a part of the cable TV standard, particularly related to two-way communications, and is an intermediate software layer designed for two-way TV services or applications which are operable on all the cable TVs.

The STB 10 includes an application unit 11, a process unit 13, and a UI rendering unit 15. If the application unit 11 in the STB 10 senses an event, the process unit 13 extracts UI data corresponding to the event, and the UI rendering unit 15 renders a UI in accordance with the UI data. Subsequently, the UI is transmitted to the DTV 20. The DTV 20 displays the UI.

In the related art UI offering system 100, the UI rendered in the STB 10 is transmitted to the DTV 20, and the DTV 20 is simply required to have a function for displaying the UI.

Accordingly, the related art UI offering system is unable to remotely transmit a UI on the home A/V network.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a home A/V network system for efficiently providing a remote UI to all of the image display apparatuses connected to a set-top box, a set-top box, an image display apparatus and a method for offering a UI.

According to an aspect of the present invention, there is provided a home network A/V network system comprising a set-top box which analyzes an event and outputs UI data corresponding to the event, and an image display apparatus which renders and displays a UI according to the UI data.

The set-top box may comprise a storage unit which stores the UI data, an application unit which senses the occurrence of the event, a UI process unit which analyzes the event and extracts UI data corresponding to the event from the storage unit, and a UI offer unit which transmits the UI data to the image display apparatus.

The UI data may be UI class information according to a UI rendering unit of the image display apparatus.

The set-top box may further comprise an input/output (I/O) queue unit which queues the UI data to transmit to the image display apparatus, and if a plurality of events are sensed, the UI process unit generates a list and messages regarding image display apparatuses corresponding to the plurality of events and provides the list and the messages to the I/O queue unit.

If the plurality of events are sensed, the UI process unit may generate a list and messages regarding image display apparatuses corresponding to the plurality of events, and the UI offer unit may transmit the UI data and the messages to the image display apparatuses based on the list.

The UI offer unit may receive responses to the messages from the image display apparatuses, and the UI process unit may write on the list that the UI data are transmitted according to the response and manage the list.

The image display apparatus may comprise a UI transmission and reception unit which receives the UI data, a UI rendering unit which renders a UI based on the UI data, and a display unit which displays the UI.

The UI data may be UI class information according to the UI rendering unit.

The UI transmission and reception unit may receive the UI data and the message regarding the image display apparatus corresponding to the event, and the image display apparatus may further comprise an I/O queue unit which queues the message.

According to another aspect of the present invention, there is provided a set-top box which is connected to at least one image display apparatus, the set-top box comprising a storage unit which stores UI data, an application unit which senses the occurrence of an event, a UI process unit which analyzes the event and extracts the UI data corresponding to the event from the storage unit, and a UI offer unit which transmits the UI data to the image display apparatus.

The UI data may be UI class information according to a UI rendering unit of the image display apparatus.

The set-top box may further comprise an I/O queue unit which queues the UI data to transmit to the image display apparatus, wherein if a plurality of events are sensed, the UI process unit generates a list and messages regarding image display apparatuses corresponding to the plurality of events and provides the list and the messages to the I/O queue unit.

If a plurality of events are sensed, the UI process unit may generate a list and messages regarding respective image display apparatuses corresponding to the plurality of events, and the UI offer unit may transmit the UI data and the messages to the image display apparatuses based on the list.

The UI offer unit may receive responses to the messages from the image display apparatuses, and the UI process unit may write on the list that the UI data are transmitted according to the response and may manage the list.

According to another aspect of the present invention, there is provided an image display apparatus which is connected to a set-top box, the image display apparatus comprising a UI transmission and reception unit which receives UI data from the set-top box, a UI rendering unit which renders a UI based on the UI data, and a display unit which displays the UI.

The UI data may be UI class information according to the UI rendering unit.

According to another aspect of the present invention, there is provided a method for offering a UI in a home A/V network system comprising at least one image display apparatus which is connected to a set-top box, the method comprising if an event occurs, analyzing the event and transmitting user interface (UI) data corresponding to the event to the image display apparatus by the set-top box, and rendering and displaying a UI according to the UI data by the image display apparatus.

The transmitting UI data may comprise sensing the occurrence of the event, analyzing the event and extracting the UI data corresponding to the event, and transmitting the UI data to the image display apparatus.

The rendering and displaying the UI may comprise receiving the UI data, rendering the UI based on the UI data, and displaying the UI.

According to another aspect of the present invention, there is provided a method for offering a user interface (UI) in a set-top box which is connected to at least one image display apparatus, the method comprising sensing the occurrence of an event, analyzing the event and extracting UI data corresponding to the event from a storage unit, and transmitting the UI data to the image display apparatus.

According to another aspect of the present invention, there is provided a method for offering a user interface (UI) in an image display apparatus which is connected to a set-top box, the method comprising receiving UI data from the set-top box, rendering a UI based on the UI data, and displaying the UI.

### BRIEF DESCRIPTION OF THE DRAWINGS

These and other aspects of the present invention will become apparent and more readily appreciated from the following description of exemplary embodiments, taken in conjunction with the accompanying drawings of which:

FIG. 1 is a block diagram illustrating a configuration of a related art UI offering system;

FIG. 2 is a block diagram illustrating a configuration of a home A/V network system according to an exemplary embodiment of the present invention;

FIG. 3 is a block diagram illustrating in detail the configuration of the home A/V network system in FIG. 2;

FIG. 4 is a block diagram illustrating a configuration of a set-top box according to another exemplary embodiment of the present invention;

FIG. 5 is a block diagram illustrating a configuration of an image display apparatus according to another exemplary embodiment of the present invention;

FIG. 6 is a flow chart illustrating a UI offering method according to an exemplary embodiment of the present invention;

FIG. 7 is a flow chart illustrating a UI offering method of a set-top box according to an exemplary embodiment of the present invention;

FIG. 8 is a flow chart illustrating a UI offering method of an image display apparatus according to an exemplary embodiment of the present invention;

FIG. 9 is a flow chart illustrating a UI offering method of a set-top box according to another exemplary embodiment of the present invention; and

FIG. 10 is a flow chart illustrating a UI offering method of an image display apparatus according to another exemplary embodiment of the present invention.

### DETAILED DESCRIPTION OF EXEMPLARY EMBODIMENTS OF THE PRESENT INVENTION

Reference will now be made in detail to exemplary embodiments of the present invention, examples of which are illustrated in the accompanying drawings, wherein like reference numerals refer to like elements throughout. The exemplary embodiments are described below in order to explain the present invention by referring to the figures.

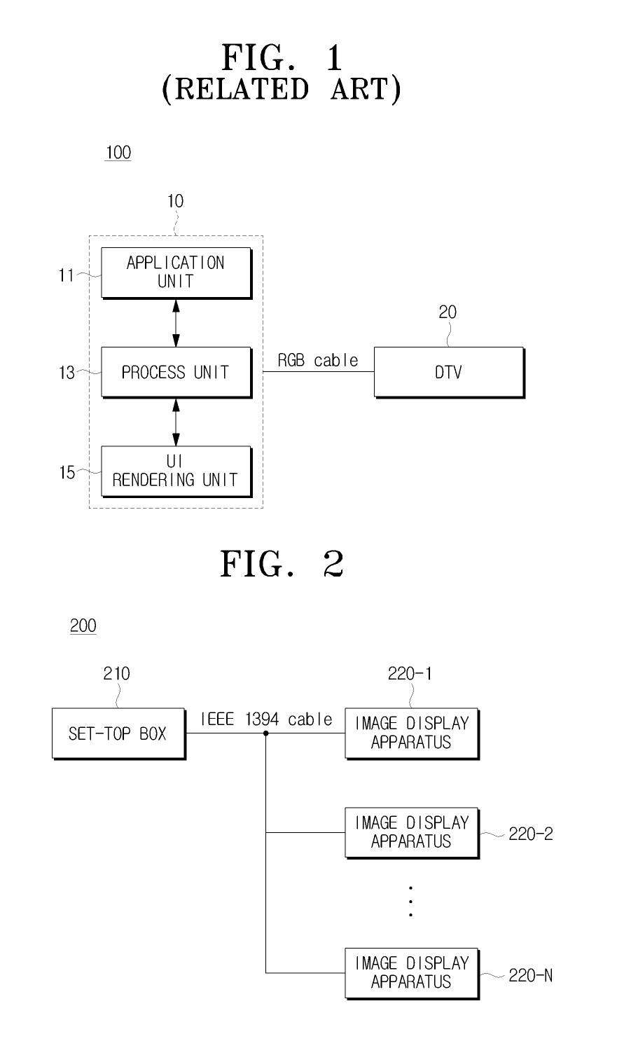

FIG. 2 is a block diagram illustrating a configuration of a home A/V network system according to an exemplary embodiment of the present invention.

With reference to FIG. 2, a home A/V network system 200 includes a set-top box 210 and a plurality of image display apparatuses, image display apparatus 220-1, image display apparatus 220-2, . . . , and image display apparatus 220-N. The set-top box 210 and the plurality of image display apparatuses 220-1, 220-2, . . . , and 220-N are connectable to each other via a IEEE 1394 cable, and transmit data using a TCP/IP networking function provided by IEEE 1394.

If an event occurs, the set-top box 210 transmits and receives data corresponding to types of the event according to a remote Abstract Windowing Toolkit (AWT) communication protocol. The types of the event are UI events such as Graphics, Widget and so on.

The AWT is a graphic user interface (GUI) package, which is a graphic user interface (GUI) mechanism of JAVA to drive the GUI, and by which a GUI including a button, check box, image, or text can be generated.

If an event occurs, the set-top box 210 analyzes the event and outputs UI data corresponding to the event to the image display apparatus 220-1.

If a plurality of events occur, the set-top box 210 outputs respective UI data corresponding to the plurality of events to the corresponding image display apparatuses where each event is carried out.

Each image display apparatus 220-1, 220-2, . . . , and 220-N renders and displays a UI according to UI data output from the set-top box 210. The image display apparatus may be a DTV.

Hereinbelow, the above described procedure is explained as an example.

If an event for displaying an electronic program guide (EPG) occurs, the set-top box analyzes the EPG displaying event, and extracts and outputs UI data corresponding to the EPG displaying event to the image display apparatus.

The image display apparatus renders and displays an EPG UI corresponding to the UI data.

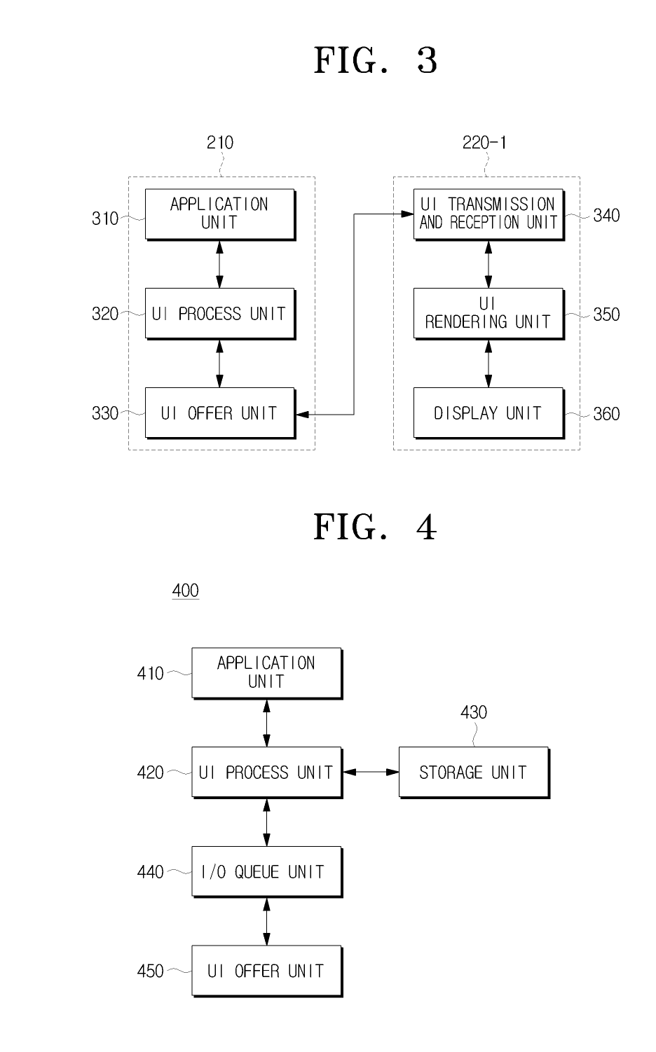

FIG. 3 is a block diagram illustrating in detail the configuration of the home A/V network system in FIG. 2. That is, FIG. 3 representatively shows the configuration of the set-top box 210 and an image display apparatus 220-1 from among the image display apparatuses 220-1, 220-2, . . . , and 220-N shown in FIG. 2.

In FIG. 3, the home A/V network system 200 includes the set-top box 210 and the image display apparatus 220-1.

The set-top box 210 includes an application unit 310, a UI process unit 320 and a UI offer unit 330.

The application unit 310 senses whether an event occurs. More specifically, the application unit 310 senses a user event generated from the image display apparatus 220-1. That is, the image display apparatus 220-1 transmits the user event generated from an input device (not shown) to the set-top box 210, and the application unit 310 senses the user event.

In more detail, the application unit 310 calls a JAVA application program interface (API) by a sensed event.

The UI process unit 320 analyzes the sensed event and extracts UI data corresponding to the event. The UI process unit 320 may be a Java virtual machine (JVM).

More specifically, the UI process unit 320 analyzes a UI package of the event using the called JAVA API, and extracts a native method according to the UI package from a storage unit (not shown). The ‘native method’ denotes a UI class for rendering the UI, and the UI classes are classified by package bundles. The native method may be a UI class according to types of the UI rendering unit 350 of the image display apparatus 220-1, that is, a window toolkit. Quicktime (QT) and shadow are examples of the window toolkit.

Throughout the description, UI data denote a native method or UI class information.

The storage unit (not shown) stores the native method (UI class information) according to the UI package. That is, the storage unit (not shown) stores the UI data.

Java AWT UI API denotes a Java class library and collection of classes for rendering a Ul. Among these, a package denotes a bundle of classes which are associated with each other.

The UI offer unit 330 transmits the UI data to the image display apparatus 220-1.

The image display apparatus 220-1 includes a UI transmission and reception unit 340, a UI rendering unit 350, and a display unit 360.

The UI transmission and reception unit 340 transmits a user event generated from the input device (not shown) to the set-top box 210, or receives UI data from the UI offer unit 330.

The UI rendering unit 350 renders a UI based on the received UI data. That is, the UI rendering unit 350 renders a UI using the UI class information included in the UI data. The UI rendering unit 350 may be a window toolkit or a graphic driver.

The display unit 360 displays the Ul.

FIG. 3 shows the configuration of only the image display apparatus 220-1, but the plurality of image display apparatuses 220-1, 220-2, . . . , and 220-N shown in FIG. 2 may be configured in the same manner.

FIG. 4 is a block diagram illustrating a configuration of a set-top box according to another exemplary embodiment of the present invention.

In FIG. 4, a set-top box 400 includes an application unit 410, a UI process unit 420, a storage unit 430, an input/output (I/O) queue unit 440, and a UI offer unit 450.

The application unit 410 senses whether one or a plurality of events occur, and may perform the same function as the application unit 310 in FIG. 3.

The UI process unit 420 analyzes a plurality of sensed events and extracts UI data corresponding to each event from the storage unit 430. The UI process unit 420 may perform the same function as the UI process unit 320 in FIG. 3.

In addition, the UI process unit 420 generates a list and a message regarding the image display apparatuses corresponding to the event.

For example, it is assumed that the plurality of events sensed from the application unit 410 include an EPG display event generated from the image display apparatus 220-1 and a game event generated from the image display apparatus 220-2, shown in FIG. 2.

In this case, the UI process unit 420 generates a list and a message, indicating that the EPG display event is generated from the image display apparatus 220-1 and the game event is generated from the image display apparatus 220-2.

The UI process unit 420 offers the list and the message to the I/O queue unit 440.

Additionally, if the UI process unit 420 transmits the message corresponding to the event and receives a response to the message, the UI process unit 420 records and manages that UI data corresponding to the event are transmitted.

The storage unit 430 stores UI data. The UI data may be a UI class according to types of the UI rendering unit of the image display apparatuses, that is, according to the type of the window toolkit. QT and shadow are examples of the window toolkits. The storage unit 430 stores UI classes corresponding to the respective window toolkits.

The storage unit 430 may be designed to pre-store the type of the UI rendering unit of the image display apparatus coupled to the set-top box 400. Alternatively, the storage unit 430 may receive the type of the UI rendering unit from the image display apparatus coupled to the set-top box 400 and store the received information. Methods for storing the UI class corresponding to the type of the UI rendering unit can be implemented in many ways and are not limited to the above.

The I/O queue unit 440 queues UI data to transmit or receive to or from the image display apparatus.

The UI offer unit 450 transmits the UI data and message to the image display apparatus based on the list, and may perform the same function as the UI offer unit 330 in FIG. 3.

Moreover, the UI offer unit 450 may receive a response to the message from the image display apparatus.

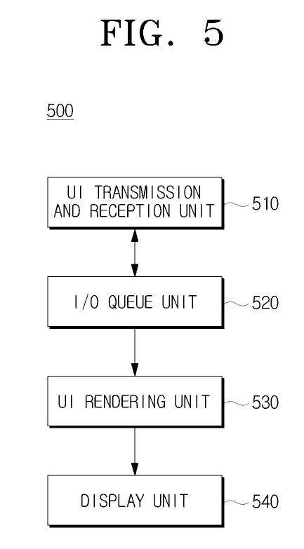

FIG. 5 is a block diagram illustrating a configuration of an image display apparatus according to another exemplary embodiment of the present invention.

In FIG. 5, the image display apparatus 500 includes a UI transmission and reception unit 510, an input/output (I/O) queue unit 520, a UI rendering unit 530 and a display unit 540.

The UI transmission and reception unit 510 receives UI data and a message from the set-top box, and may perform the same function as the UI transmission and reception unit 340 in FIG. 3.

The UI transmission and reception unit 510 transmits a response to the message to the set-top box.

The I/O queue unit 520 queues the message.

The UI rendering unit 530 and display unit 540 may perform the same function as the UI rendering unit 350 and display unit 360, respectively, so the detailed description is omitted for the brevity.

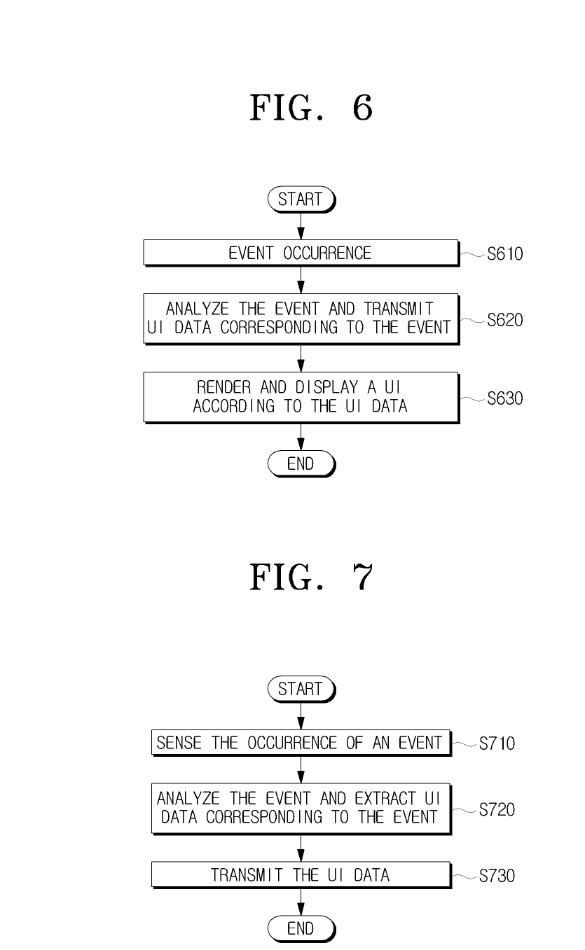

FIG. 6 is a flow chart illustrating a UI offering method according to an exemplary embodiment of the present invention.

With reference to FIG. 6, an event occurs at operation S610. The set-top box in the home A/V network system analyzes the event and transmits UI data corresponding to the event to the image displaying apparatus at operation S620.

At operation S630, the image displaying apparatus renders and displays a UI according to the UI data.

Therefore, the home A/V network system can efficiently offer remote UIs to all the image display apparatuses coupled to the set-top box.

FIG. 7 is a flow chart illustrating a UI offering method of a set-top box according to an exemplary embodiment of the present invention.

In FIG. 7, the set-top box senses occurrence of an event at operation S710. The set-top box analyzes the event and extracts UI data corresponding to the event at operation S720.

The set-top box transmits the UI data to the image display apparatus at operation S730.

For example, if the set-top box senses that a user event occurs, the set-top box calls a UI API. That is, java.awt class is called by a command ‘application.java’.

Then, the set-top box analyzes the event and extracts UI data corresponding to the event. For example, if the analyzed event is ‘qt.buttonRect(0,0)’, ‘buttonRect(0,0) class information of qt is extracted.

‘qt.buttonRect(0,0)’ class information is transmitted to the image display apparatus.

Throughout the description, UI data denote a native method or UI class information.

Accordingly, the set-top box uses java application-based services such as OCAP and interworks with the home A/V network system so that a remote UI can be offered.

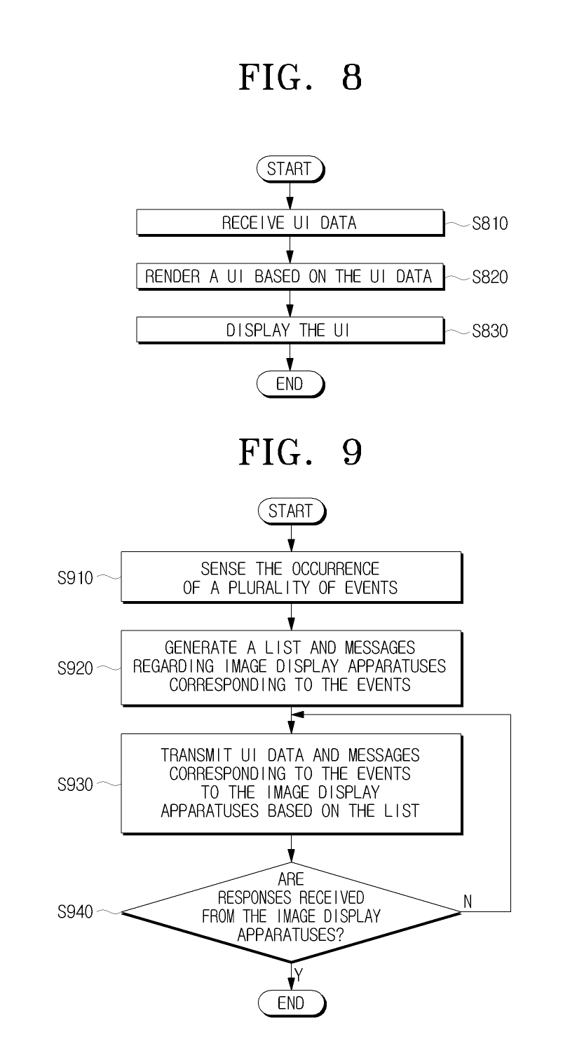

FIG. 8 is a flow chart illustrating a UI offering method of an image display apparatus according to an exemplary embodiment of the present invention.

In FIG. 8, at operation S810, the image display apparatus receives UI data corresponding to an event from the set-top box.

The image display apparatus renders a UI based on the UI data at operation S820 and displays the UI at operation S830.

For example, the image display apparatus may have buttons based on the ‘qt.buttonRect(0,0)’ class information received from the set-top box, and implement colors for the buttons. In other words, the image display apparatus renders a UI for the buttons and displays the button UI.

Accordingly, the image display apparatus can offer a java application-based UI without a separate Java virtual machine (JVM) so that a cost necessary for offering the java application-based UI can be minimized.

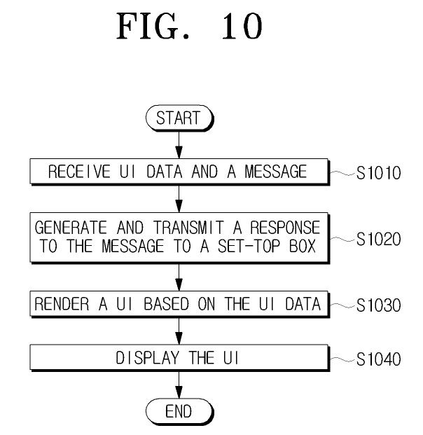

FIG. 9 is a flow chart illustrating a UI offering method of a set-top box according to another exemplary embodiment of the present invention.

In FIG. 9, the set-top box senses the occurrence of an event at operation S910. If a plurality of events occur, a list and messages regarding image display apparatuses corresponding to the events are generated at operation S920.

The set-top box analyzes the plurality of events and extracts UI data corresponding to the events.

Based on the list, the UI data and message are transmitted to each of the image display apparatuses at operation S930.

For example, if it is written in the list that an EPG display event is generated from the image display apparatus 220-1 and a game event is generated from the image display apparatus 220-2, the set-top box transmits UI data and a message which correspond to the EPG display event to the image display apparatus 220-1 and transmits UI data and a message which correspond to the game event to the image display apparatus 220-2.

Subsequently, if the set-top box receives a response to the message from each image display apparatus at operation S940:Y, the set-top box records in the list that UI data are transmitted.

Alternatively, if the set-top box does not receive responses to the messages from some of the image display apparatuses at operation S940:N, the set-top box may retransmit the UI data and messages corresponding the events to the image display apparatuses which did not transmit the responses.

Therefore, it is confirmed that the UI data corresponding to each event are normally transmitted.

FIG. 10 is a flow chart illustrating a UI offering method of an image display apparatus according to another exemplary embodiment of the present invention.

In FIG. 10, the image display apparatus receives UI data and a message corresponding to an occurring event at operation S1010, and generates a response to the message and transmits the response to the set-top box at operation S1020. The response may be a message which confirms that the UI data corresponding to the event which occurs in the image display apparatus is received.

The image display apparatus renders a UI based on the UI data at operation S1030, and displays the UI at operation S1040.

As can be appreciated from the above description, remote UIs can be efficiently offered to all the image display apparatuses coupled to the set-top box.

In addition, the set-top box can offer UIs, using a JAVA application of the OCAP service in association with the home A/V network system.

Furthermore, as a JAVA application-based UI can be offered without a separate JAVA virtual machine (JVM) for the image display apparatus, a cost necessary for offering the JAVA application-based UI can be minimized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A system comprising:
a set-top box which analyzes an event and outputs user interface (UI) data corresponding to the event; and
an image display apparatus which renders and displays a UI according to the UI data.

2. The system of claim 1, wherein the set-top box comprises:
a storage unit which stores the UI data;
an application unit which senses an occurrence of the event;
a UI process unit which analyzes the event and extracts UI data, which corresponds to the event, from the storage unit; and
a UI offer unit which transmits the UI data to the image display apparatus.

3. The system of claim 2, wherein the UI data comprises UI class information according to a UI rendering unit of the image display apparatus.

4. The system of claim 2, wherein the set-top box further comprises an input/output (I/O) queue unit which queues the UI data to transmit the UI data to the image display apparatus, and
if a plurality of events are sensed, the UI process unit generates a list and messages regarding a plurality of image display apparatuses corresponding to the plurality of events and provides the list and the messages to the I/O queue unit.

5. The system of claim 2, wherein if a plurality of events are sensed, the UI process unit generates a list and messages regarding a plurality of image display apparatuses corresponding to the plurality of events, and
the UI offer unit transmits the UI data and the messages to the plurality of image display apparatuses based on the list.

6. The system of claim 5, wherein the UI offer unit receives responses to the messages from the plurality of image display apparatuses, and
the UI process unit writes on the list that the UI data are transmitted according to the responses, and manages the list.

7. The system of claim 1, wherein the image display apparatus comprises:
a UI transmission and reception unit which receives the UI data;
a UI rendering unit which renders a UI based on the UI data; and
a display unit which displays the UI.

8. The system of claim 7, wherein the UI data comprise UI class information according to the UI rendering unit.

9. The system of claim 7, wherein the UI transmission and reception unit receives the UI data and a message regarding the image display apparatus corresponding to the event, and
the image display apparatus further comprises an I/O queue unit which queues the message.

10. A set-top box which is coupled to at least one image display apparatus, the set-top box comprising:
a storage unit which stores user interface (UI) data;
an application unit which senses an occurrence of an event;
a UI process unit which analyzes the event and extracts UI data corresponding to the event from the storage unit; and
a UI offer unit which transmits the UI data, which is extracted from the storage unit, to the image display apparatus.

11. The set-top box of claim 10, wherein the UI data comprises UI class information according to a UI rendering unit of the image display apparatus.

12. The set-top box of claim 10, further comprising an input/output (I/O) queue unit which queues the UI data to transmit the UI data to the image display apparatus,
wherein if a plurality of events are sensed, the UI process unit generates a list and messages regarding a plurality of image display apparatuses corresponding to the plurality of events, and provides the list and the messages to the I/O queue unit.

13. The set-top box of claim 10, wherein if a plurality of events are sensed, the UI process unit generates a list and messages regarding respective image display apparatuses of a plurality of image display apparatuses corresponding to the plurality of events, and
the UI offer unit transmits the UI data and the messages to the image display apparatuses based on the list.

14. The set-top box of claim 13, wherein the UI offer unit receives responses to the messages from the plurality of image display apparatuses, and
the UI process unit writes on the list that the UI data are transmitted according to the responses, and manages the list.

15. An image display apparatus which is coupled to a set-top box, the apparatus comprising:
a user interface (UI) transmission and reception unit which receives UI data from the set-top box;
a UI rendering unit which renders a UI based on the UI data; and
a display unit which displays the Ul.

16. The image display apparatus of claim 15, wherein the UI data comprise UI class information according to the UI rendering unit.

17. A method for offering a user interface (UI) in a home A/V network system comprising at least one image display apparatus which is coupled to a set-top box, the method comprising:
(a) if an event occurs, analyzing the event and transmitting user interface (UI) data corresponding to the event to the image display apparatus by the set-top box; and
(b) rendering and displaying a UI according to the UI data by the image display apparatus.

18. The method of claim 17, wherein the transmitting comprises:
(a-1) sensing the occurrence of the event;
(a-2) analyzing the event and extracting the UI data corresponding to the event; and
(a-3) transmitting the UI data to the image display apparatus.

19. The method of claim 17, wherein the rendering and displaying comprises:
receiving the UI data;
rendering the UI based on the UI data; and
displaying the UI.

20. A method for offering a user interface (UI) in a set-top box which is coupled to at least one image display apparatus, the method comprising:
sensing an occurrence of an event;
analyzing the event and extracting UI data corresponding to the event; and
transmitting the UI data.

21. A method for offering a user interface (UI) in an image display apparatus which is coupled to a set-top box, the method comprising:
receiving UI data from the set-top box;
rendering a UI based on the UI data; and
displaying the UI.
